(19) United States
(12) Patent Application Publication
(10) Pub. No.: US 2011/0091778 A1
(43) Pub. Date: Apr. 21, 2011

(54) FUEL CELL AND FUEL CELL STACK

(76) Inventors: Hironori Kambara, Osaka (JP); Toshiyuki Fujita, Osaka (JP); Tomohisa Yoshie, Osaka (JP); Yoshihiro Tsukuda, Osaka (JP); Chikaaki Kogure, Osaka (JP); Shunsuke Sata, Osaka (JP)

(21) Appl. No.: 12/992,509

(22) PCT Filed: May 8, 2009
(86) PCT No.: PCT/JP2009/058678

§ 371 Date: Nov. 12, 2010

Related U.S. Application Data
(60) Provisional application No. 61/076,329, filed on Jun. 27, 2008.

(30) Foreign Application Priority Data
May 13, 2008 (JP) 2008-126379

(51) Int. Cl. H01M 8/06; H01M 8/24

(52) U.S. Cl. 429/408; 429/456

(57) ABSTRACT

The present invention relates to a small fuel cell and a small fuel cell stack each allowing for improved output. Conventionally, in a direct methanol fuel cell, carbon dioxide gas produced at an anode electrode side is exhausted together with a methanol aqueous solution. From the methanol aqueous solution, the carbon dioxide gas is separated, and then the methanol aqueous solution is reused as fuel. In this case, a liquid-gas separation device needs to be provided additionally, which results in a large fuel cell with an increased weight, disadvantageously. The present invention is made to solve such a problem by providing a fuel cell including a first unit cell having a cathode electrode, an electrolyte membrane, an anode electrode, and an anode collector layer in this order; and one or more spacers arranged on the anode collector layer. The anode collector layer has a fuel flow path for supplying fuel to the anode electrode, and a through hole for exhausting a reaction product generated by reaction in the anode electrode. Each of the spacers has an exhaust flow path for exhausting the reaction product to outside the fuel cell. The through hole and the exhaust flow path communicate with each other.

### TECHNICAL FIELD

The present invention relates to a fuel cell and a fuel cell stack allowing for downsizing and improved output.

### BACKGROUND ART

In recent years, expectations for fuel cells are increasing as small power sources for portable electronic devices used in the information society because they have a potential of achieving high power generation efficiency as an individual power generating device. The fuel cell is a chemical cell that utilizes electrochemical reaction to supply electrons to a portable electronic device or the like. The electrochemical reaction involves oxidizing a fuel (such as hydrogen, methanol, ethanol, hydrazine, formalin, or formic acid) at the anode and reducing oxygen in air at the cathode.

Of such a wide variety of fuel cells, a polymer electrolyte membrane fuel cell (hereinafter, abbreviated as “PEMFC”), which employs a proton-exchanged, ion-exchanged membrane as an electrolyte membrane, will be likely to be put into practical use as a small power source due to the following reasons: the PEMFC achieves a high power generation efficiency even when operated at a low temperature of 100° C. or smaller; heat does not need to be externally applied to the PEMFC, unlike fuel cells operating at a high temperature such as phosphoric acid fuel cells and solid oxide fuel cells; and no large-scale auxiliary equipment is required.

Such a PEMFC is supplied with a fuel such as a hydrogen gas from a high-pressure gas tank or a mixed gas of a hydrogen gas and a carbon dioxide gas obtained by decomposing an organic liquid fuel using a reformer.

A PEMFC directly extracting protons and electrons for power generation from a methanol aqueous solution supplied to its anode is a direct methanol fuel cell (hereinafter, abbreviated as “DMFC”). The DMFC does not require any reformer and will be therefore more likely to be put into practical use as a small power source as compared with the PEMFC. In addition, as a fuel, the DMFC employs the methanol aqueous solution, i.e., a liquid under an atmospheric pressure. Thus, such a fuel with a high volume energy density can be handled with a simple container without using a high-pressure gas tank. Therefore, the DMFC is excellent in safety as a small power source and is implementable with a small fuel container. For these reasons, the DMFC is drawing attention in terms of application to small power sources of portable electronic devices, in particular, usage as a substitute of secondary batteries for portable electronic devices.

In the DMFC, the following reactions take place at the anode and the cathode thereof, respectively:

Anode:CH₃OH+H₂O→CO₂+6H⁺+6e⁻

Cathode:O₂+4H⁺+4e⁻→2H₂O

As such, in the DMFC, carbon dioxide gas is generated at the anode electrode side whereas water is generated at the cathode electrode side. Since a reaction product such as carbon dioxide gas is usually produced in the DMFC, removal of the reaction product has to be done in addition to the supply of fuel. In general, in the DMFC, the carbon dioxide gas stays as gas bubbles in a flow path for the methanol aqueous solution fuel, provided in the anode electrode side, and is exhausted by the flow of the methanol aqueous solution.

Conventionally, the DMFC is additionally provided with a liquid-gas separation device or the like to separate the carbon dioxide gas from the methanol aqueous solution, and the methanol aqueous solution from which the carbon dioxide gas has been thus separated is reused as fuel. This results in, however, increased size and weight of the fuel cell system, disadvantageously.

Japanese Patent No. 3877516 (Patent Document 1) discloses a fuel cell including a cell with an anode and a cathode arranged on an electrolyte membrane, and a pair of plates for sandwiching the cell such that ribs formed at main surfaces of the plates are interposed between the cell and the plates. The fuel cell generates power by supplying a liquid fuel to the anode side and supplying an oxidant gas to the cathode side. Between ribs of the plate positioned at the anode side, a plurality of flow paths are formed. The liquid fuel is supplied to one or more first flow paths selected from the plurality of flow paths. A gas produced by the power generation is exhausted into second flow paths other than the first flow paths out of the plurality of flow paths.

According to such a configuration, an amount of fuel supplied to the first flow paths but unused and exhausted to outside the fuel cell can be reduced. Hence, no liquid-gas separation device or the like needs to be provided. Thus, downsizing and weight reduction of the fuel cell can be realized to some extent. However, such a fuel cell described in Patent Document 1 still has room for improvement in view of reduction in size, thickness and weight as well as improvement in power generation efficiency of the fuel cell.

### PRIOR ART DOCUMENTS

### Patent Documents

Patent Document 1: Japanese Patent No. 3877516

### SUMMARY OF THE INVENTION

### Problems to be Solved by the Invention

In the fuel cell described in Patent Document 1, one plate is provided with the plurality of flow paths including both the flow paths for exhausting the carbon dioxide and the flow paths (fuel flow paths) for supplying the fuel. Because the flow paths for exhausting the carbon dioxide are thus formed in the plate having the fuel flow paths formed therein, an area for the anode electrode to be supplied with the methanol aqueous solution is reduced. Accordingly, the fuel cannot be supplied uniformly to the entire anode electrode, disadvantageously. This means that fuel is locally in short supply, resulting in decreased power generation efficiency.

The present invention is made to solve the foregoing problems, and its object is to provide a fuel cell and a fuel cell stack that can be smaller, thinner, and lighter in weight and can exhaust a reaction product efficiently.

### Means for Solving the Problems

The present invention provides a fuel cell including: a first unit cell including a cathode electrode, an electrolyte membrane, an anode electrode, and an anode collector layer in this order; and one or more spacers arranged on the anode collector layer. The anode collector layer has a fuel flow path for supplying fuel to the anode electrode and a through hole for exhausting a reaction product generated by reaction in the anode electrode. Each of the spacers has an exhaust flow path for exhausting the reaction product to outside the fuel cell, and the through hole and the exhaust flow path communicate with each other.

In one preferred embodiment of the fuel cell according to the present invention, the first unit cell is in a shape of an elongated strip with a longer side and a shorter side, and each of the spacers is arranged such that a longitudinal direction of each of the spacers intersects with a direction of the longer side of the first unit cell. Also in the present invention, the through hole preferably has an inner wall surface having a water-repellent property.

Further, the present invention provides a fuel cell stack at least including: the above-described fuel cell according to the present invention; and a second unit cell including a cathode electrode, an electrolyte membrane, an anode electrode, and an anode collector layer in this order. The second unit cell is arranged on the fuel cell such that the cathode electrode of the second unit cell is in contact with the spacers.

Furthermore, the present invention provides a fuel cell stack at least including: a unit cell layer in which two or more unit cells are arranged in the same plane with a gap therebetween; and a spacer layer arranged on the unit cell layer. Each of the unit cells includes a cathode electrode, an electrolyte membrane, an anode electrode, and an anode collector layer in this order. The spacer layer is constituted of two or more spacers. The spacers are arranged to intersect with the gap provided in the unit cell layer. The anode collector layer has a fuel flow path for supplying fuel to the anode electrode and a through hole for exhausting a reaction product generated by reaction in the anode electrode. Each of the spacers has an exhaust flow path for exhausting the reaction product to outside the fuel cell stack, and the through hole and the exhaust flow path communicate with each other. Preferably, the unit cells and/or the spacers are in a shape of an elongated strip.

### Effects of the Invention

A fuel cell according to the present invention can be smaller, thinner, and reduced in weight, and can exhaust a reaction product efficiently. Also, power generation efficiency is improved therein. Such a fuel cell according to the present invention can be suitably used as a unit constituting a fuel cell stack. Further, the present invention provides a fuel cell stack that can be smaller, thinner, and reduced in weight and can exhaust a reaction product efficiently. Furthermore, the present invention provides a fuel cell stack allowing for improved power generation efficiency and high power density.

### BRIEF DESCRIPTION OF THE DRAWINGS

FIG. 1 is an exploded perspective view schematically showing a preferred exemplary fuel cell of the present invention.

FIG. 2 is a cross sectional view schematically showing the preferred exemplary fuel cell of the present invention.

FIG. 3 is a cross sectional view schematically showing a preferred exemplary fuel cell stack of the present invention.

FIG. 4 is an exploded perspective view schematically showing a preferred exemplary fuel cell stack of the present invention.

FIG. 5 is a cross sectional view schematically showing another preferred exemplary fuel cell stack of the present invention.

FIG. 6 is a cross sectional view schematically showing still another preferred exemplary fuel cell stack of the present invention.

FIG. 7 is a cross sectional view schematically showing yet another preferred exemplary fuel cell stack of the present invention.

FIG. 8 is a cross sectional view showing a preferred exemplary spacer used for the fuel cell stack shown in FIG. 7.

FIG. 9 is a perspective view schematically showing still another preferred fuel cell stack of the present invention.

FIG. 10 is a cross sectional view schematically showing the fuel cell stack shown in FIG. 9.

### MODES FOR CARRYING OUT THE INVENTION

The following describes embodiments of fuel cells and fuel cell stacks according to the present invention in detail. Each of the embodiments described below presents a direct methanol fuel cell (DMFC), which directly extracts protons from methanol for power generation, employs a methanol aqueous solution as fuel, and employs air (specifically, oxygen in air) as an oxidizing agent. However, in the present invention, the type of the fuel cell is not limited to the DMFC and the present invention is applicable to fuel cells of the other types described above. Also, the fuel and the oxidizing agent are not particularly limited.

### First Embodiment

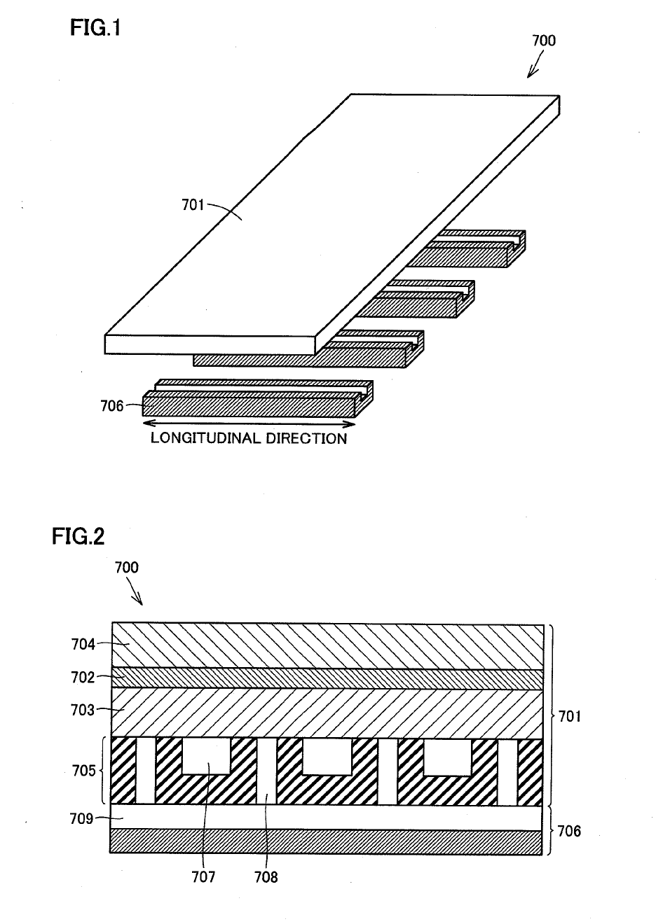

FIG. 1 and FIG. 2 are an exploded perspective view and a cross sectional view, each of which schematically shows a preferred exemplary fuel cell of the present invention. A unit cell 701, which constitutes a fuel cell 700 shown in FIG. 1 and FIG. 2, includes an electrolyte membrane 702, an anode electrode 703 disposed on one surface of electrolyte membrane 702, a cathode electrode 704 disposed on the other surface of electrolyte membrane 702, and an anode collector layer 705 disposed in contact with an opposite surface of anode electrode 703 to the electrolyte membrane 702 side. Fuel cell 700 is constituted by unit cell 701 and one or more spacers 706 arranged on anode collector layer 705. The term “unit cell” herein refers to one unit constituting a fuel cell, and is defined as a structure including a membrane electrode assembly (MEA) and optionally other components combined with the membrane electrode assembly for the purpose of providing a power generation function or other purposes. The other components are not particularly limited, and examples thereof include an anode collector layer, a cathode collector layer, a separator, and the like. The term “membrane electrode assembly (MEA)” is defined as an assembly at least including an electrolyte membrane and anode and cathode electrodes sandwiching the electrolyte membrane therebetween.

Anode collector layer 705 includes fuel flow paths 707 each of which is a space for transportation of fuel, and through holes 708 for exhausting a reaction product generated by reaction in anode electrode 703. Each of through holes 708 penetrates anode collector layer 705 in a direction of thickness thereof. Each of spacers 706 includes an exhaust flow path 709 for exhausting the reaction product generated by the reaction in anode electrode 703 to outside fuel cell 700. Spacer 706 is provided just below the openings of through holes 708 so that exhaust flow path 709 provided therein communicates with through holes 708. The methanol aqueous solution, which serves as the fuel, is supplied to anode electrode 703 via fuel flow paths 707, and the carbon dioxide generated is exhausted to outside via through hole 708 in anode collector layer 705 and exhaust flow path 709 in spacer 706. The air serving as the oxidizing agent is supplied from atmospheric air to cathode electrode 704.

According to the present invention, exhaust flow path 709 for exhausting the reaction product can be secured while forming complicated fuel flow paths. For example, fuel flow paths 707 can be formed in the form of a mesh, and through holes 708 are formed in areas surrounded by fuel flow paths 707 thus formed in the form of a mesh. Since the exhaust ports for the carbon dioxide are in a shape of a hole like through holes 708 as such, minute and complicated fuel flow paths can be formed, which allows the methanol aqueous solution to be supplied uniformly to the entire surface of anode electrode 703, thereby reducing non-uniform power generation. Non-uniform power generation raises a problem of shortened life of the fuel cell such as degradation of a catalyst layer and a polymer constituting the electrolyte membrane, due to locally generated heat or local shortage of fuel. Such a problem can be overcome in the present invention.

### Second Embodiment

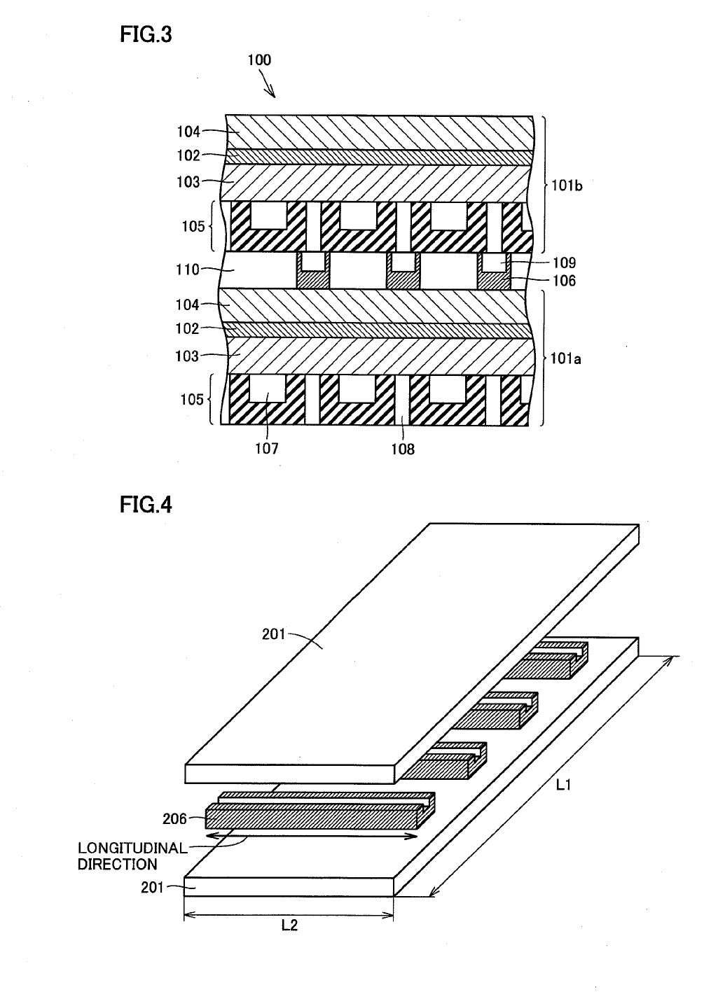

FIG. 3 is a cross sectional view schematically showing a preferred exemplary fuel cell stack of the present invention. A fuel cell stack 100 shown in FIG. 3 includes a first unit cell 101a and a second unit cell 101b, each of which includes an electrolyte membrane 102, an anode electrode 103 disposed on one surface of electrolyte membrane 102, a cathode electrode 104 disposed on the other surface of electrolyte membrane 102, and an anode collector layer 105 disposed in contact with an opposite surface of anode electrode 103 to the electrolyte membrane 102 side. Fuel cell stack 100 is formed by arranging first unit cell 101a and second unit cell 101b with one or more spacers 106 interposed therebetween so that cathode electrode 104 of first unit cell 101a faces anode collector layer 105 of second unit cell 101b.

Anode collector layer 105 includes fuel flow paths 107 each of which is a space for transportation of fuel, and through holes 108 for exhausting a reaction product generated by reaction in anode electrode 103. Each of through holes 108 penetrates anode collector layer 105 in a direction of thickness thereof. Each of spacers 106 includes an exhaust flow path 109 for exhausting the reaction product generated by the reaction in anode electrode 103 to outside fuel cell stack 100. Spacer 106 is provided just below the openings of through holes 108 so that exhaust flow path 109 provided therein communicates with through holes 108. The methanol aqueous solution, which serves as the fuel, is supplied to anode electrode 103 via fuel flow paths 107, and the carbon dioxide generated is exhausted to outside via through hole 108 in anode collector layer 105 and exhaust flow path 109 in spacer 106. The air serving as the oxidizing agent is supplied from the atmospheric air to cathode electrode 104. FIG. 3 shows an example including two stacked unit cells, but the fuel cell stack of the present invention may include three or more stacked unit cells.

Each component of the fuel cell stack will be described below in detail. It should be noted that the description below is also applied to the foregoing first embodiment.

<Electrolyte Membrane>

Electrolyte membrane 102 may be formed of any material as long as the material has a proton conductivity and is electrically insulative, but a conventionally known appropriate polymer membrane, inorganic membrane, or composite membrane is preferably used. Examples of the polymer membrane include: a perfluorosulfonic acid based electrolyte membrane such as NAFION® provided by DuPont, a DOW membrane provided by the Dow Chemical Co., ACIPLEX® provided by Asahi Kasei Corporation, and Flemion® provided by Asahi Glass Company, as well as a hydrocarbon based electrolyte membrane formed of polystyrene sulfonic acid, sulfonated polyetheretherketone, or the like. Examples of the inorganic membrane include: membranes formed of phosphate glass, cesium hydrogen sulfate, polytungstophosphoric acid, ammonium polyphosphate, and the like. Examples of the composite membrane include a GORE-SELECT membrane (GORE-SELECT® provided by GORE).

In the case where the fuel cell stack (or fuel cell) reaches a temperature of around 100° C. or exceeds 100° C., it is preferable to use, as the material of the electrolyte membrane, a membrane having a high ion conductivity even upon low moisture content, such as a membrane formed of sulfonated polyimide, 2-acrylamide-2-methylpropanesulfonic acid (AMPS), sulfonated polybenzimidazole, phosphonated polybenzimidazole, cesium hydrogen sulfate, ammonium polyphosphate, ionic liquid (ambient temperature molten salt), or the like.

The electrolyte membrane preferably has a proton conductivity rate of 10⁻⁵ S/cm or greater. It is more preferable to use a polymer electrolyte membrane having a proton conductivity rate of 10⁻³ S/cm or greater, such as a perfluorosulfonic acid polymer or a hydrocarbon based polymer.

<Anode Electrode and Cathode Electrode>

Anode electrode 103 includes a catalyst for accelerating oxidation of the fuel. On the catalyst, the fuel causes oxidation reaction to generate protons and electrons. On the other hand, cathode electrode 104 includes a catalyst for accelerating reduction of the oxidizing agent. On the catalyst, the oxidizing agent combines with the protons and the electrons to cause reduction reaction.

As each of anode electrode 103 and cathode electrode 104, for example, there can be used a stacked structure of a catalyst layer including a carrier that carries a catalyst and an electrolyte, and a porous base provided on the catalyst layer. In this case, the anode catalyst in the anode catalyst layer has a function of accelerating a rate of reaction of producing protons and electrons from, for example, methanol and water, the electrolyte has a function of conducting the produced protons to electrolyte membrane 102, and the anode carrier has a function of conducting the produced electrons to an anode porous base. The anode porous base has pores allowing the methanol and the water to be supplied to the anode catalyst layer, and also has a function of conducting the electrons from the anode carrier to anode collector layer 105.

On the other hand, the cathode catalyst in the cathode catalyst layer has a function of accelerating a rate of reaction of producing water from oxygen, protons, and electrons, the electrolyte has a function of conducting protons from electrolyte membrane 102 to the vicinity of the cathode catalyst, and the cathode carrier has a function of conducting electrons from a cathode porous base to the cathode catalyst. The cathode porous base has pores allowing the oxygen to be supplied to the cathode catalyst layer, and also has a function of conducting electrons from an external wire (not shown in figures) or spacers 106 to the cathode catalyst layer.

Because the catalysts have electron conductivity while the anode carrier and the cathode carrier have the functions of conducting electrons, anode electrode 103 and cathode electrode 104 do not need to include carrier necessarily. Further, anode electrode 103 and cathode electrode 104 do not necessarily need to include the anode porous base and the cathode porous base respectively. In this case, the anode catalyst layer and the cathode catalyst layer are directly formed on electrolyte membrane 102, and the anode catalyst layer exchanges electrons with the anode collector layer whereas the cathode catalyst layer exchanges electrons with an external wire (not shown in figures) or the spacers.

Examples of the anode catalyst and cathode catalyst include: noble metals such as Pt, Ru, Au, Ag, Rh, Pd, Os, and Ir; base metals such as Ni, V, Ti, Co, Mo, Fe, Cu, Zn, Sn, W, and Zr; oxides, carbides, and carbonitrides of these noble metals or base metals; and carbon. One or a combination of not less than two of these materials can be used as the catalysts. The anode catalyst and the cathode catalyst may be catalysts of the same type or different types.

Each of the carriers used for anode electrode 103 and cathode electrode 104 is preferably formed of a carbon-based material having a high electric conductivity. Examples of the carbon-based material are: acetylene black, Ketjen Black®, amorphous carbon, carbon nanotube, carbon nanohorn, and the like. Exemplary materials other than the carbon-based materials include: noble metals such as Pt, Ru, Au, Ag, Rh, Pd, Os, and Ir; base metals such as Ni, V, Ti, Co, Mo, Fe, Cu, Zn, Sn, W, and Zr; and oxides, carbides, nitrides, and carbonitrides of these noble metals or base metals. One or a combination of not less than two of these materials can be used as the carriers. Further, materials with a proton conductivity, specifically, sulfated zirconia, zirconium phosphate, and the like may be used as the carriers.

The carrier used for the anode electrode in the present invention preferably has a hydrophilic surface. Preferably used as a method of providing a hydrophilic surface is a method of modifying the surface with a hydrophilic functional group such as a carboxyl group or a hydroxyl group. Specific exemplary methods thereof are: a method of providing surface modification to the carbon surface by means of graft polymerization, a method of providing surface modification using a silane coupling agent, and the like. In this way, the fuel (methanol aqueous solution) is retained in pores of the anode catalyst layer, which results in good diffusion of the fuel and the protons as well as a reduced amount of oxygen reaching the catalyst from exhaust flow paths 109 and through holes 108. Accordingly, output characteristics can be prevented from decreasing due to reaction of the oxygen at the anode catalyst layer.

The material of the electrolyte used for each of anode electrode 103 and cathode electrode 104 is not particularly limited as long as the material has a proton conductivity and is electrically insulative, but is preferably a solid or gel not dissolved by the fuel such as methanol. Specifically, the material of the electrolyte is preferably an organic polymer having a strong acid group such as a sulfonic acid or phosphoric acid group, or a weak acid group such as a carboxyl group. Examples of the organic polymer include: sulfonic acid group containing perfluorocarbon (NAFION provided by DuPont), carboxyl group containing perfluorocarbon (Flemion provided by Asahi Kasei Corporation), polystyrene sulfonic acid copolymer, polyvinyl sulfonic acid copolymer, ionic liquid (ambient temperature molten salt), sulfonated imide, 2-acrylamide-2-methylpropanesulfonic acid (AMPS), and the like. In the case where the above-described carrier with a proton conductivity is used, the carrier conducts the protons, so anode electrode 103 and cathode electrode 104 do not need to include the electrolytes necessarily.

Each of the anode catalyst layer and the cathode catalyst layer preferably has a thickness of 0.2 mm or smaller in order to reduce resistance in proton conduction, resistance in electron conduction, and resistance in diffusion of the fuel (for example, methanol) or the oxidizing agent (for example, oxygen). Further, each of the anode catalyst layer and the cathode catalyst layer preferably has a thickness of at least 0.1 μm or greater because a sufficient catalyst needs to be carried in order to improve output of the fuel cell stack (or fuel cell).

Each of the anode porous base and the cathode porous base is preferably formed of an electrically conductive material. For example, a carbon paper, a carbon cloth, a metal foam, a metal sintered compact, a nonwoven fabric of a metal fiber, or the like can be used therefor. Exemplary metals used for the metal foam, the metal sintered compact, and the nonwoven fabric of the metal fiber are: noble metals such as Pt, Ru, Au, Ag, Rh, Pd, Os, and Ir; base metals such as Ni, V, Ti, Co, Mo, Fe, Cu, Zn, Sn, W, and Zr; and oxides, carbides, nitrides, and carbonitrides of these noble metals or base metals. In the case where the anode porous base and the cathode porous base are provided, the anode porous base is disposed in anode electrode 103 at the anode collector layer 105 side (side opposite to the electrolyte membrane 102 side) and the cathode porous base is disposed in cathode electrode 104 at the exterior side of the unit cell (side opposite to the electrolyte membrane 102 side).

<Anode Collector Layer>

Anode collector layer 105 has a function of exchanging electrons with anode electrode 103. In the present invention, anode collector layer 105 includes fuel flow paths 107, and through holes 108 for exhausting the reaction product generated by reaction in anode electrode 103.

Exemplary materials suitable for anode collector layer 105 are: a carbon material; an electrically conductive polymer; noble metals such as Au, Pt, and Pd; metals other than the noble metals, such as Ti, Ta, W, Nb, Ni, Al, Cr, Ag, Cu, Zn, and Su; Si; nitrides, carbides, and carbonitrides of these metals; and alloys such as stainless steel, Cu—Cr, Ni—Cr, and Ti—Pt. More preferably, the material for the anode collector layer includes at least one element selected from a group consisting of Pt, Ti, Au, Ag, Cu, Ni, and W. The element(s) thus included allow for reduced specific resistance of anode collector layer 105, whereby voltage decrease caused by the resistance of anode collector layer 105 can be reduced. Accordingly, higher power generation characteristics can be attained. When a poor corrosion-resistant metal such as Cu, Ag, or Zn is used under an acidic atmosphere, a corrosion-resistant noble metal such as Au, Pt, or Pd, the other corrosion-resistant metal, an electrically conductive polymer, an electrically conductive nitride, an electrically conductive carbide, an electrically conductive carbonitride, an electrically conductive oxide, or the like can be used for surface coating. This achieves extended lives of the fuel cell and the fuel cell stack employing the fuel cell.

Anode collector layer 105 has through holes 108, each of which penetrates anode collector layer 105 in the direction of thickness thereof. The reaction product generated in anode electrode 103 such as carbon dioxide becomes gas bubbles. When the gas bubbles become large, the gas bubbles are exhausted from through holes 108 to exhaust flow paths 109 of spacers 106. Providing the through holes, a distance to each of exhaust flow paths 109 for exhausting the reaction product becomes shortest, thus achieving improved efficiency of exhausting the reaction product.

Each of through holes 108 preferably has an inner wall surface treated to be water-repellent. Such a water-repellent inner wall surface of through hole 108 prevents the reaction product from being exhausted poorly by a liquid such as the fuel blocking through hole 108. The water-repellent treatment is performed to the inner wall surface of through hole 108 by application of a material including a water-repellent material such as a fluororesin, a plasma graft polymerization treatment, an ion beam reforming treatment, an electron beam irradiation treatment, or the like.

The cross sectional shape of through hole 108 is not particularly limited, and may be, for example, circular, elliptic, quadrangular, triangular, or the like. The through hole preferably has an internal diameter falling within a range of 10 μm to 1 mm. Further, a distance (pitch) between through holes 108 may range from 100 μm to 10 mm. In order to prevent leakage of the methanol aqueous solution that is the fuel, each through hole 108 preferably has an internal diameter smaller than 500 μm. Meanwhile, in view of the efficiency for exhausting carbon dioxide, through hole 108 preferably has an internal diameter of 100 μm or greater, and the distance between through holes 108 is preferably smaller than 1 mm. The number and cross sectional areas of through holes 108 are preferably determined in consideration of the electric resistance of the anode collector layer 105, a contact area of anode collector layer 105 and anode electrode 103, and the like. Through holes 108 can be formed by providing holes in a plate or foil made of the above-described material by means of etching or the like to penetrate the plate or foil, for example. It should be noted that the plurality of through holes 108 may communicate with one another.

Each of fuel flow paths 107 is a flow path for supplying the fuel to anode electrode 103, and is formed separately from through holes 108. In this way, the supply of the fuel and the exhaust of the carbon dioxide can be performed separately. Further, in the present invention, anode collector layer 105 has both the function of supplying the fuel and the function of exhausting carbon dioxide. This contributes to achievement of smaller and thinner fuel cell and fuel cell stack with reduced weights.

The shape of fuel flow path 107 is not particularly limited, and for example has a quadrangular cross sectional shape as shown in FIG. 3. Fuel flow path 107 can be formed by forming one or two or more grooves on a surface of anode collector layer 105 at the anode electrode 103 side. The fuel flow path preferably has a width of 0.1-1 mm and preferably has a cross sectional area of 0.01-1 mm². The width and cross sectional area of the fuel flow path are preferably determined in consideration of the electric resistance of anode collector layer 105, the contact area of anode collector layer 105 and anode electrode 103, and the like.

The length of a region in which anode electrode 103 and anode collector layer 105 are not in contact with each other (i.e., total length of the internal diameter of through hole 108 and the width of fuel flow path 107) is preferably smaller than 1 mm at maximum. On the other hand, an area in which anode electrode 103 and anode collector layer 105 are in contact with each other is preferably equal to or larger than 20% of the area of the surface of anode electrode 103 at the anode collector layer 105 side. The same holds true for a case where another layer is provided between anode electrode 103 and anode collector layer 105. <Spacer>

Each of spacers 106 is arranged between cathode electrode 104 of first unit cell 101a and anode collector layer 105 of second unit cell 101b. In this way, space portions 110 are secured between cathode electrode 104 of first unit cell 101a and anode collector layer 105 of second unit cell 101b. Each of space portions 110 thus secured allows oxygen in the atmospheric air to be efficiently supplied to cathode electrode 104 of first unit cell 101a via space portion 110.

Spacer 106 includes exhaust flow path 109 for exhausting the reaction product generated in anode electrode 103 to outside the fuel cell stack. Exhaust flow path 109 communicates with through hole 108 of the anode collector layer of second unit cell 101b.

The spacer thus configured is used to stack the unit cells in the direction of thickness thereof to construct the fuel cell stack, thereby preventing the reaction product generated in the second unit cell from being exhausted to the vicinity of the cathode electrode of the first unit cell and thereby allowing the reaction product to be exhausted to outside the fuel cell stack via the exhaust flow path in the spacer. In this way, the supply of oxygen to the cathode electrode is not prevented by the reaction product exhausted in the vicinity of the cathode electrode of the first unit cell, whereby high output characteristics can be maintained.

The material of spacer 106 is not particularly limited as long as it has a strength sufficient to secure space portion 110 between the unit cells even when external force is exerted to the fuel cell stack, but the material thereof is preferably an electrically conductive material. The use of the electrically conductive material allows first unit cell 101a and second unit cell 101b to be electrically connected in series without using any external wire, and is therefore advantageous in reducing the size of the fuel cell stack. Exemplary suitable materials for spacer 106 can be the same materials as those for anode collector layer 105, specifically, are carbon materials; electrically conductive polymers; noble metals such as Au, Pt, and Pd; metals other than the noble metals, such as Ti, Ta, W, Nb, Ni, Al, Cr, Ag, Cu, Zn, and Su; Si; and nitrides, carbides, and carbonitrides of these metals; as well as alloys such as stainless steel, Cu—Cr, Ni—Cr, and Ti—Pt. More preferably, the material of spacer 106 includes at least one element selected from a group consisting of Pt, Ti, Au, Ag, Cu, Ni, and W. The element(s) thus included allows for reduced specific resistance in spacer 106, whereby the voltage is less likely to decrease due to the resistance of spacer 106. Accordingly, high power generation characteristics can be attained. In the case where a poor corrosion-resistant metal such as Cu, Ag, or Zn is used under an acidic atmosphere, a corrosion-resistant noble metal such as Au, Pt, or Pd, the other corrosion-resistant metal, an electrically conductive polymer, an electrically conductive nitride, an electrically conductive carbide, an electrically conductive carbonitride, an electrically conductive oxide, or the like can be used as a surface coating therefor. This achieves extended lives of the fuel cell and the fuel cell stack employing the fuel cell.

The shape of spacer 106 is not particularly limited as long as it allows space portion 110, which is supplied with oxygen, to be secured between the unit cells, allows exhaust flow path 109 formed in spacer 106 to communicate with through hole 108 of anode collector layer 105 adjacent to spacer 106, and allows spacer 106 to have at least a portion exposed to outside fuel cell stack 100. However, the shape thereof is preferably of pillar having a length allowing spacer 106 to have a surface extending across the unit cells when stacked thereon, in order to achieve uniform thickness of space portion 110 and large volume of space portion 110. In the case where spacer 106 has such a shape of pillar, the cross sectional shape thereof is not particularly limited but can be elliptic, quadrangular, or the like, for example. In the case where spacer 106 is formed of an electrically conductive material and serves to achieve electric connection between the unit cells, spacer 106 preferably has a rectangular parallelepiped shape. Such a spacer 106 having the rectangular parallelepiped shape can be brought into contact with an adjacent layer at their surfaces, thereby achieving reduced electric contact resistance.

The width of spacer 106 is not particularly limited as long as it has a size sufficient to cover through hole 108, but is preferably 0.5 mm or greater to secure the structural strength of the fuel cell stack. Further, the width of spacer 106 is preferably 5 mm or smaller to facilitate the supply of oxygen to space portion 110. The thickness of spacer 106 is preferably 0.1 mm or greater to facilitate the supply of oxygen to space portion 110 formed by spacer 106, and is preferably 5 mm or smaller to prevent the size of the fuel cell stack from being large. The thickness of spacer 106 more preferably falls within a range of 0.2 mm-1 mm.

The number of spacers 106 provided between first unit cell 101a and second unit cell 101b is not particularly limited as long as space portion 110 can be secured, but is preferably two or more in order to stably secure space portion 110 even when external force is exerted to fuel cell stack 100.

In order to reduce resistance in exhausting the reaction product at anode electrode 103, it is preferable that an contact area of the spacer side surface of the layer adjacent to spacer 106 with spacer 106 is 20% or greater of the entire spacer side surface thereof. Also, the contact area thereof is preferably 80% or smaller in order to reduce resistance in supplying oxygen into space portion 110.

Spacers 106 are preferably integrated with anode collector layer 105 adjacent to spacers 106. The term “integrated” in the present invention refers to a state in which spacers 106 are not separated therefrom without an external pressure, specifically, it refers to a state in which spacers 106 are joined thereto by means of a chemical bond, an anchor effect, an adhesive force, or the like. It should be noted that in the present specification, the structure in which a unit cell (for example, second unit cell 101b in FIG. 3) and the spacer(s) are integrated as such is referred to as “fuel cell”. Such a fuel cell (spacer-integrated fuel cell) can be suitably used as a unit that constitutes the fuel cell stack.

Spacers 106 and anode collector layer 105 thus integrated provide improved hermeticity at the respective joined surfaces of spacers 106 and anode collector layer 105, thereby preventing the reaction product from leaking from the joined surfaces. As a result, the reaction product can be prevented from leaking from the joined surfaces to the atmosphere at the cathode electrode, and therefore prevents the reaction product from blocking the supply of oxygen. Accordingly, high output of fuel cell stack 100 can be maintained.

An exemplary method for integrating spacers 106 and anode collector layer 105 is adhesion using an adhesive agent such as a thermosetting resin, diffusion bonding, ultrasonic bonding, laser welding, or the like.

The shape of exhaust flow path 109 formed in each of spacers 106 is not particularly limited as long as it allows exhaust flow path 109 to communicate with through hole 108 of anode collector layer 105 adjacent to spacer 106, allows exhaust flow path 109 to have at least a portion exposed to outside the fuel cell stack, and allows the reaction product, which is exhausted from through hole 108, to get out of the fuel cell stack via exhaust flow path 109. However, the cross sectional shape thereof can be quadrangular as shown in FIG. 3, for example. Exhaust flow path 109 can be formed by forming one or two or more grooves on a surface of the spacer 106 to be joined with anode collector layer 105. Apart from forming the grooves as such, the exhaust flow path can be formed using a hollow spacer to provide an opening that communicates through hole 108 with the hollow portion of the spacer at a portion of the hollow spacer to be joined with through hole 108 of anode collector layer 105. In this way, the exhaust flow path can be formed by the hollow portion of the spacer. The width of exhaust flow path 109 preferably falls within a range of 0.1-1 mm, and the cross sectional area of exhaust flow path 109 preferably falls within a range of 0.01-1 mm². In the case where an electrically conductive material is used for the spacer, the width and cross sectional area of exhaust flow path 109 are preferably determined in consideration of the electric resistance of spacer 106, a contact area of spacer 106 and anode collector layer 105, and the like. Exhaust flow path 109 can be formed by means of etching processing, press work, cutting work, or the like.

Further, exhaust flow path 109 preferably includes therein a catalyst for burning an organic compound component in the reaction product to be exhausted from through hole 108. The catalyst thus included allows the organic compound in the exhausted carbon dioxide to react with oxygen in the air, thereby burning the organic compound. This can reduce an amount of the organic compound, which is mainly made up of vapor of methanol and is to be exhausted to outside the fuel cell. Accordingly, the amount of harmful organic compound to be exhausted to outside the fuel cell can be reduced as compared with that in the conventional one. Further, heat resulting from the burning is conducted to the fuel cell to activate catalytic reaction, thereby achieving improved power generation efficiency.

As the catalyst for burning the organic compound, it is preferable to use particles of Pt, and the catalyst is preferably supported by a carrier. As the carrier, a porous body formed of a metal, a metal oxide, or the like is preferably used to improve heat-resisting property.

FIG. 4 is an exploded perspective view schematically showing a preferred exemplary fuel cell stack of the present invention. A unit cell 201 constituting the fuel cell stack shown in FIG. 4 is in a shape of an elongated strip (more specifically, rectangular parallelepiped shape) with a longer side and a shorter side. Likewise, each of spacers 206 has a shape elongated in the longitudinal direction thereof (in a shape of an elongated strip with a longer side and a shorter side). Unit cell 201 and spacers 206 are stacked so that the longer side direction of unit cell 201 intersects with the longitudinal direction (longer side direction) of each spacer 206. In the example shown in FIG. 4, spacer 206 has an exhaust flow path extending substantially in parallel with the longitudinal direction of spacer 206. Thus, the exhaust flow path of spacer 206 extends to intersect with the longer side direction of unit cell 201 (extends substantially in parallel with the shorter side direction of unit cell 201).

A ratio L1/L2 of a length L1 of the longer side of unit cell 201 to a length L2 of the shorter side thereof is preferably 5 or greater, and is more preferably 10 or greater. In this way, a distance in which the reaction product generated in the anode electrode travels in the exhaust flow path of spacer 206 before being exhausted to outside the fuel cell stack is shorter than that in a case of using a unit cell having a square external shape, i.e., having L1/L2 of 1 and having an area equal to that of unit cell 201. Hence, the resistance in exhausting the reaction product can be reduced more to exhaust the reaction product more efficiently. This results in reduced gas pressure of the reaction product in the fuel cell stack, thereby preventing the reaction product from leaking from the joined interface of spacer 206 and the anode collector layer to the atmosphere at the cathode electrode as well as preventing leakage of the reaction product into the fuel flow path. In this way, the reaction product can be prevented from blocking the supply of fuel or air, thus achieving stable output of the fuel cell stack.

Further, when length L2 of unit cell 201 is not more than several mm and the spacers are disposed along the longer side direction of unit cell 201, most of the portion between the unit cells are occupied by spacers 206. In such a case, spacers 206 are preferably provided to intersect with the longer side direction of unit cell 201 to secure the space portions between the unit cells. In this way, air can be supplied well to the portion between the unit cells.

### Third Embodiment

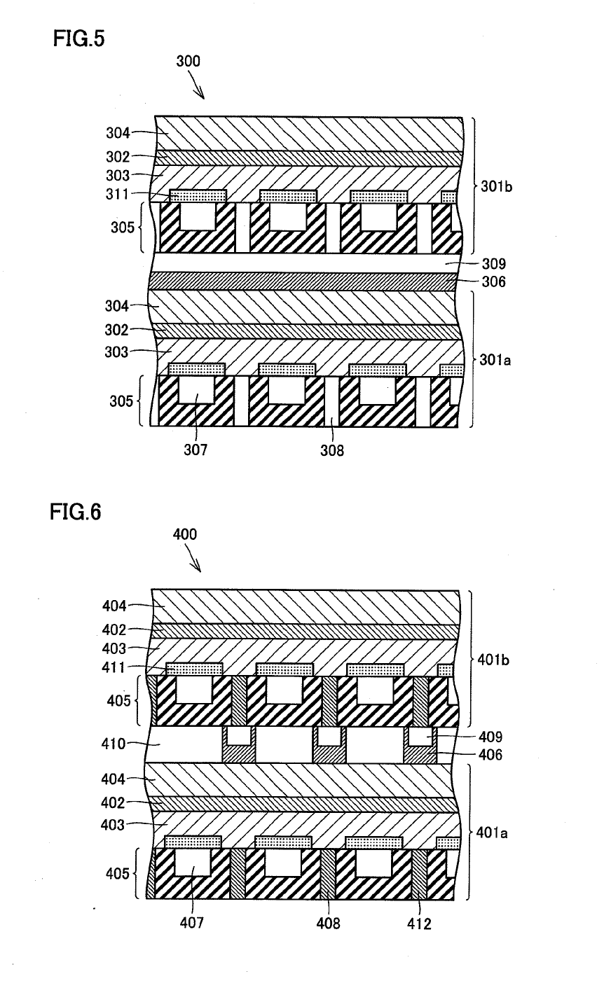

FIG. 5 is a cross sectional view schematically showing another preferred exemplary fuel cell stack of the present invention. A fuel cell stack 300 shown in FIG. 5 has a configuration similar to that of the foregoing second embodiment, except that fuel permeation layers 311 are provided. The following describes the fuel permeation layer in detail.

<Fuel Permeation Layer>

Fuel permeation layer 311 is a layer allowing the fuel to pass therethrough, has a diffusion resistance of the fuel in the thickness direction thereof, and has a function of restricting a permeation flux of the fuel. Further, fuel permeation layer 311 is not porous and has a function of blocking permeation of the gas in the thickness direction thereof. As shown in FIG. 5, fuel permeation layer 311 is formed between an anode collector layer 305 and an anode electrode 303 so as to cover an opening at the anode electrode 303 side of a fuel flow path 307.

Fuel permeation layer 311 thus provided with such a configuration allows restriction of permeation flux of the fuel even when a high concentration methanol aqueous solution is used as the fuel, thereby restraining crossover of the fuel to a cathode electrode 304 side. In this way, high output characteristics can be maintained. Because such a high concentration methanol aqueous solution can be used as the fuel, the fuel tank therefor can be smaller. It should be noted that in the case where water generated at the cathode electrode 304 side is utilized, 100% methanol can be supplied as the fuel. Specifically, the water generated at the cathode electrode 304 side is diffused to anode electrode 303 via an electrolyte membrane 302, so power can be generated by reaction of the water with the methanol supplied via fuel permeation layer 311.

If no fuel permeation layer 311 is provided and fuel flow path 307 is shallow in depth, the material of anode electrode 303 disposed on fuel flow path 307 may be introduced into fuel flow path 307, whereby the fuel is less likely to be supplied. Accordingly, in order to sufficiently secure the depth of fuel flow path 307, the thickness of an anode collector layer 305 may have to be thick, disadvantageously. Such a disadvantage resulting from the blockage of fuel flow path 307 by the material of anode electrode 303 or the like can be avoided by providing fuel permeation layer 311, whereby fuel flow path 307 can be shallow in depth. In this way, anode collector layer 305 can be thinner. As a result, the fuel cell stack can be further thinner.

Further, because fuel permeation layer 311 is not porous and has the function of preventing permeation of gas, carbon dioxide is not accumulated in fuel flow path 307 to allow for stable supply of fuel. This can prevent such a problem that carbon dioxide is accumulated in fuel flow path 307 and prevents the supply of methanol aqueous solution to anode electrode 303 to decrease the output of the unit cell.

As described above, fuel permeation layer 311 has the diffusion resistance of the fuel in the thickness direction thereof, has a function of restricting the permeation flux of the fuel, more preferably, is formed of a material not allowing permeation of gas therethrough. Fuel permeation layer 311 having such a function is not limited in terms of its shape, and may be provided with minute pores penetrating the fuel permeation layer in the thickness direction thereof to provide a function of allowing permeation of fuel, for example. In the case where the fuel is a methanol aqueous solution, fuel permeation layer 311 is preferably formed of a polymer membrane, an inorganic membrane, or a composite membrane. Examples of the polymer membrane include: a silicon rubber; perfluorosulfonic acid based electrolyte membranes such as NAFION provided by DuPont, a DOW membrane provided by the Dow Chemical Co., ACIPLEX® provided by Asahi Kasei Corporation, and Flemion provided by Asahi Glass Company; and a hydrocarbon based electrolyte membrane formed of sulfonated polyimide, polystyrene sulfonic acid, sulfonated polyetheretherketone, or the like. Examples of the inorganic membrane include: membranes formed of a porous glass, a porous zirconia, a porous alumina, and the like. Examples of the composite membrane include a GORE-SELECT membrane provided by GORE.

Further, fuel permeation layer 311 may be formed of a photosensitive resin. As the photosensitive resin, a negative type photosensitive resin having an acid resistance and a methanol resistance is preferable, and an epoxy-based photosensitive resin, a polyimide-based photosensitive resin, a polyacryl based photosensitive resin, or the like is more preferable. In the case where the fuel permeation layer is formed using the photosensitive resin, photolithography or the like can be used, so the fuel permeation layer can be patterned into a desired shape. Hence, even when the fuel permeation layer is formed on fuel flow paths having a width of approximately several ten to several hundred μm and having a minute pitch of approximately several ten to several hundred μm, the fuel permeation layer can be formed readily on the fuel flow paths while an exposed portion in which the fuel permeation layer is not formed is left at the anode collector layer surface. In this way, an electrically conductive path can be secured between anode electrode 303 and anode collector layer 305.

### Fourth Embodiment

FIG. 6 is a cross sectional view schematically showing still another exemplary fuel cell stack of the present invention. A fuel cell stack 400 shown in FIG. 6 has a configuration similar to that of the fuel cell stack of the foregoing third embodiment except that water-repellent porous portions 412 are formed in through holes 408 of an anode collector layer 405. The following describes the water-repellent porous portion in detail.

<Water-Repellent Porous Portion>

Water-repellent porous portion 412 is formed of a water-repellent porous material filling a through hole 408 of anode collector layer 405, and is provided to prevent the methanol aqueous solution from leaking to an exhaust flow path 409 of each spacer 406 via through hole 408. Moreover, the water-repellent porous portion may be constituted by a layer formed of a water-repellent porous material formed on a surface of anode collector layer 405 at a side opposite to the anode electrode 403 side. Alternatively, the water-repellent porous portion may be formed in through hole 408 and on the surface of anode collector layer 405 at the side opposite to the anode electrode 403 side. Water-repellent porous portion 412 is impermeable to liquid such as water or a methanol aqueous solution, is permeable to gas, and thus has a liquid-gas separation ability. Preferably, water-repellent porous portion 412 is electrically conductive.

As a material for water-repellent porous portion 412, there can be used a mixture of a material having a liquid-gas separation ability and an electrically conductive material. An example of such a mixture is a mixture of a fluorine-based polymer such as PTFE (Polytetrafluoroethylene) or PVDF (Polyvinylidenfluoride) and acetylene black, Ketjen Black, amorphous carbon, carbon nanotube, or carbon nanohorn. Water-repellent porous portion 412 may be formed within through hole 408 of anode collector layer 405 as shown in FIG. 6, or may be formed on a surface of anode collector 405 to cover through hole 408.

Water-repellent porous portion 412 thus provided can prevent the reaction product from being poorly exhausted to outside due to the methanol aqueous solution entering exhaust flow path 409, thereby achieving stable output characteristics of the fuel cell stack. Also, it can prevent the methanol aqueous solution from leaking to outside the fuel cell stack via exhaust flow path 409, thus achieving improved reliability of the fuel cell stack.

### Fifth Embodiment

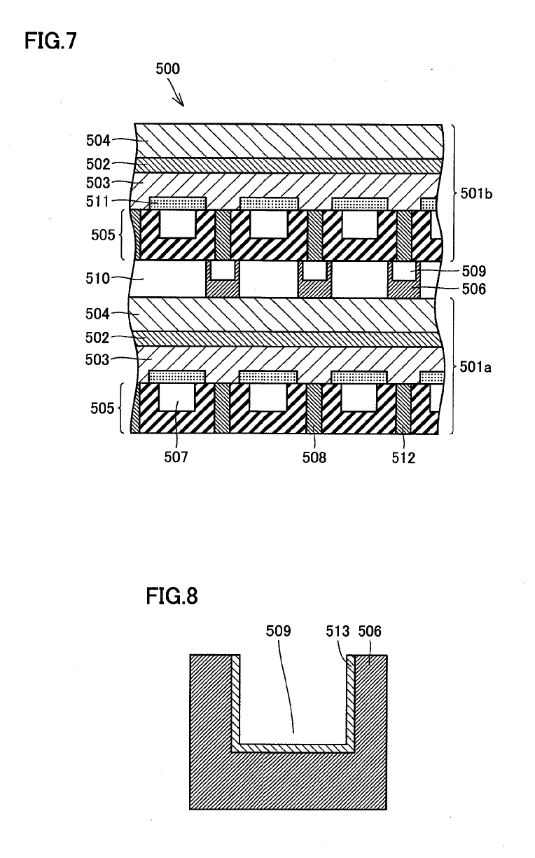

FIG. 7 is a cross sectional view schematically showing yet another preferred exemplary fuel cell stack of the present invention and FIG. 8 is a cross sectional view of a spacer 506 used in the fuel cell stack. A fuel cell stack 500 shown in FIG. 7 has a configuration similar to that of the fuel cell stack of the foregoing fourth embodiment except that each spacer 506 is constituted by a porous body and has an exhaust flow path wall 513 with a gas-permeation retarding property on a surface of an exhaust flow path 509 that constitutes an inner wall thereof. The following describes spacer 506 and exhaust flow path wall 513 shown in FIG. 7 and FIG. 8 in detail.

Spacer 506 has a function similar to that of the spacer described in the foregoing second embodiment except that spacer 506 is constituted by a porous body and has a function of allowing gas to come into the spacer from the outside thereof. A material for spacer 506 is not particularly limited as long as it is porous, but is preferably an electrically conductive material. Examples of the material include: noble metals such as Au, Pt, and Pd; metals other than the noble metals such as Ti, Ta, W, Nb, Ni, Al, Cr, Ag, Cu, Zn, and Su; Si; and nitrides, carbides and carbonitrides of these metals; as well as foam metals, metal sintered compacts, metal woven fabrics, and metal nonwoven fabrics that employ alloys such as stainless steel, Cu—Cr, Ni—Cr, and Ti—Pt. Spacer 506 preferably has a porosity of 20% or greater in order to reduce diffusion resistance of oxygen to a portion of a cathode electrode 504 being in contact with spacer 506. Also, spacer 506 preferably has a porosity of 98% or smaller in order to secure strength sufficient to secure space portions 510 even when external force is exerted to fuel cell stack 500.

<Exhaust Flow Path Wall>

Exhaust flow path wall 513 has a function of preventing passage of the reaction product through exhaust flow path 509, and is formed to cover a surface forming exhaust flow path 509 of spacer 506 (a surface that constitutes the inner wall of exhaust flow path 509). Instead of forming exhaust flow path wall 513 to cover the inner wall of exhaust flow path 509, exhaust flow path wall 513 may be formed to be embedded in pores at the inner wall surface of exhaust flow path 509 of spacer 506. Further, instead of forming exhaust flow path wall 513 on the surface forming exhaust flow path 509 of spacer 506, exhaust flow path wall 513 may be formed on a stack interface (a surface of anode collector layer 505 which forms exhaust flow path 509) of spacer 506 and anode collector layer 505 of second unit cell 501b.

A material of exhaust flow path wall 513 is not particularly limited as long as it has a gas-permeation retarding property. In the case where exhaust flow path wall 513 is formed to cover the inner wall surface of exhaust flow path 509, exhaust flow path wall 513 is preferably formed of a film-shaped polymer substrate, inorganic substrate, or metal substrate in order to improve the adhesion between exhaust flow path wall 513 and the inner wall surface of exhaust flow path 509. Exhaust flow path wall 513 is more preferably formed of a film substrate made of the material used for spacer 506, or a film substrate made of any one of a silicon resin, a polycarbonate resin, a phenol resin, a polyolefin resin, an epoxy resin, a polyethylene terephthalate resin, a polypropylene resin, a polyimide resin, a polyamide resin, and a polyamideimide resin, each of which is thermostable at a temperature of 100° C. or greater. Further, in the case where exhaust flow path wall 513 is formed to be embedded in the pores at the inner wall surface of exhaust flow path 509 of spacer 506, as the material of exhaust flow path wall 513, it is preferable to use a sealing material containing any one of heat-resistant Teflon resin, silicon resin, epoxy resin, and olefin resin as a main component.

In the case where the film substrate is used as exhaust flow path wall 513, exhaust flow path wall 513 can be formed by integrating the film substrate and the inner wall surface of exhaust flow path 509 of spacer 506 by means of adhesion employing an adhesive agent or thermocompression bonding, laser welding, diffusion bonding, or a sintering method. In the case where the sealing material is used, a sealing material is applied using a screen method, an ink jet method, a spray method, or the like so as to fill the pores formed in the inner wall surface of exhaust flow path 509, and is then cured using a curing method suitable for the sealing material such as ultraviolet curing or thermal curing, thereby forming exhaust flow path wall 513. Exhaust flow path wall 513 may be formed after exhaust flow path 509 of spacer 506 is formed, or exhaust flow path wall 513 may be formed in advance in spacer 506 before exhaust flow path 509 is formed.

Exhaust flow path wall 513 thus provided allows the reaction product generated at anode electrode 503 to be exhausted to outside fuel cell stack 500 without directly exhausting it to atmosphere at the cathode electrode, while supplying oxygen efficiently to the contact surface of cathode electrode 504 with spacer 506. In this way, cathode overvoltage can be reduced to improve power generation characteristics of the fuel cell stack.

### Sixth Embodiment

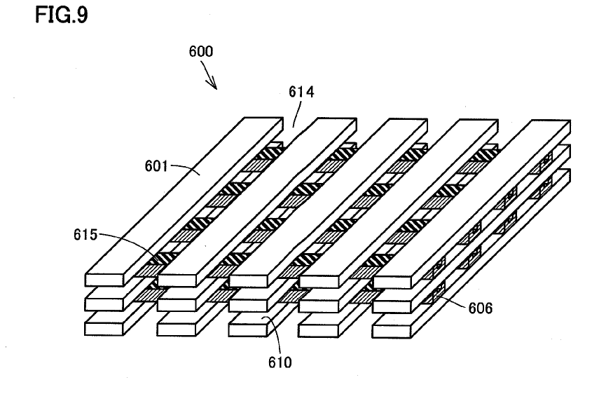

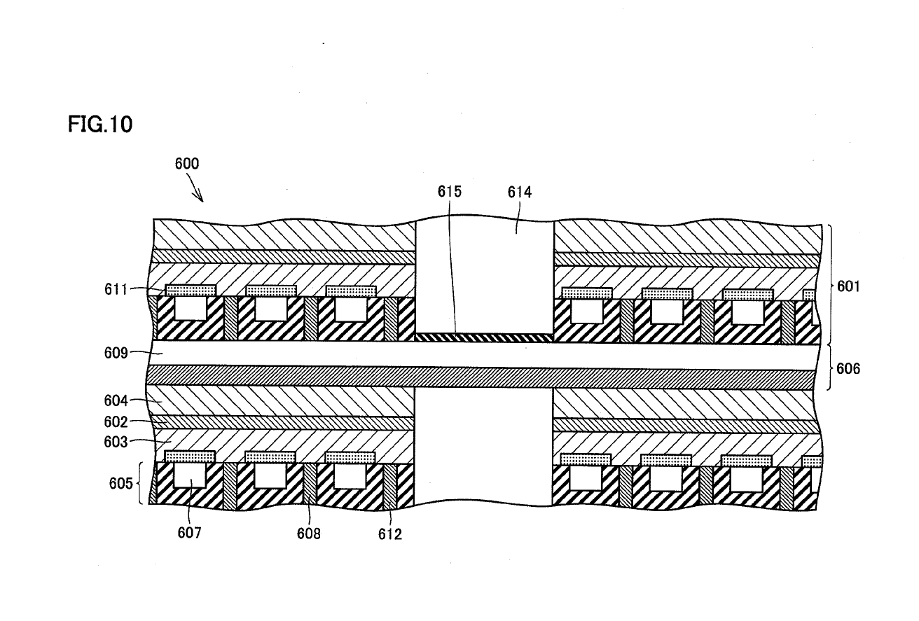

FIG. 9 and FIG. 10 are a perspective view and a cross sectional view both schematically showing still another preferred exemplary fuel cell stack of the present invention. Referring to FIG. 9, a fuel cell stack 600 shown in FIG. 9 and FIG. 10 is formed by disposing unit cell layers and spacer layers alternately. Each of the unit cell layers includes a plurality of unit cells 601 in a shape of an elongated strip with a longer side and a shorter side. In each of the unit cell layer, unit cells 601 are arranged in the same plane with gaps 614 therebetween so that the longer sides of unit cells 601 face one another and cathode electrodes and anode electrodes are respectively disposed in the same directions. Each of the spacer layers includes a plurality of spacers 606 in shape of an elongated strip with a longer side and a shorter side arranged in the same plane. Spacers 606 are disposed to intersect with gaps 614 of the unit cell layers. Further, referring to FIG. 10, in fuel cell stack 600, a gas-permeation retarding layer 615 is provided at a portion facing gap 614 of each unit cell layer in spacer 606, so as to cover an exhaust flow path 609. The other configurations are similar to those of the fuel cell stack of the foregoing fourth embodiment.

According to the fuel cell stack having the above-described configuration, gaps 614 provided in the unit cell layers and space portions 610 disposed between the unit cell layers communicate with one another three-dimensionally to improve diffusion of air. In other words, the air having entered fuel cell stack 600 can be supplied to the inside of fuel cell stack 600 via gaps 614 and space portions 610 thus communicating with one another, by means of natural convection or diffusion thereof. Moreover, the air is naturally diffused well in fuel cell stack 600. The air in fuel cell stack 600 is heated by heat resulting from power generation, and is then exhausted to outside via gaps 614 and space portions 610 communicating with one another, by means of the convection, and air is efficiently introduced thereinto from a side face or lower face of the fuel cell stack. Accordingly, auxiliary equipment for supplying air such as an air pump or a fan is not necessarily required. This leads to reduced size of a fuel cell system that employs such a fuel cell stack. Further, even if the auxiliary equipment such as an air pump or a fan is used, wind force required to supply the air to the inside of the fuel cell stack can be reduced. This leads to reduced power consumption and reduced size of the auxiliary equipment.

The air having entered the inside of fuel cell stack 600 from the uppermost face or lowermost surface of fuel cell stack 600 via gaps 614 is convected or diffused in space portions 610 between the unit cell layers, in the direction of shorter side of unit cell 601, and is supplied to cathode electrode 604 of unit cell 601. In order to shorten a distance in which the air travels upon supplying the air, the shorter side of the unit cell preferably has a length of 10 mm or smaller, more preferably of 5 mm or smaller. In this way, the resistance in supplying the air can be reduced to prevent reduced output resulting from shortage of supplied air, even in the case of passive air supply that does not employ any auxiliary equipment such as a fan or a blower.

Spacers 606 are preferably stacked to intersect with gaps 614. This can reduce the area in which spacers 606 and unit cells 601 are in contact, thereby attaining a large area in which unit cells 601 are directly exposed to space portions 610. In this way, the resistance in supplying oxygen in the air to cathode electrodes 604 of unit cells 601 can be reduced, thus maintaining the output characteristics.

In each of spacers 606, a portion of exhaust flow path 609 facing gap 614 provided in the unit cell layer is preferably covered with gas-permeation retarding layer 615 having a gas-permeation retarding property. In this way, the reaction product exhausted from anode electrode 603 to exhaust flow path 609 is prevented from being exhausted to space portion 610 or gap 614 in fuel cell stack 600 via the portion of exhaust flow path 609 facing gap 614, and can be therefore exhausted directly to outside fuel cell stack 600. Accordingly, the reaction product can be prevented from blocking the supply of air by the reaction product being exhausted to space portion 610 or gap 614 in fuel cell stack 600, thereby restraining reduced output of fuel cell stack 600. The following describes gas-permeation retarding layer 615 in detail.

<Gas-Permeation Retarding Layer>

Gas-permeation retarding layer 615 has a gas-permeation retarding property, and is disposed to cover a portion of exhaust flow path 609 facing gap 614 in the unit cell layer. In this way, the reaction product in exhaust flow path 609 can be prevented from being exhausted directly to gap 614.

A material of gas-permeation retarding layer 615 is not particularly limited as long as it has a gas-permeation retarding property. However, for prevention of leakage of the reaction product from the stacked interface of spacer 606 and gas-permeation retarding layer 615, it is preferable to use a film-shaped polymer substrate, inorganic substrate, or metal substrate in order to improve adhesion to the surface of spacer 606. More preferably, gas-permeation retarding layer 615 is formed of a film substrate made of the material for spacer 606, or a film substrate made of any one of a silicon resin, a polycarbonate resin, a phenol resin, a polyolefin resin, an epoxy resin, a polyethylene terephthalate resin, a polypropylene resin, a polyimide resin, a polyamide resin, and a polyamideimide resin, each of which is thermostable at a temperature 100° C. or greater.

Gas-permeation retarding layer 615 is formed by integrating the above-described film substrate with a portion other than exhaust flow path 609 in the surface of spacer 606 in which exhaust flow path 609 is formed, by means of adhesion that employs an adhesive agent or thermocompression bonding, laser welding, diffusion bonding, or a sintering method.

### EXAMPLES

The following describes the present invention more in detail with reference to examples, but the present invention is not limited to these.

### Example 1

In the present example, a fuel cell stack (fuel cell stack of Example 1) was fabricated which had a structure similar to that of fuel cell stack 300 shown in FIG. 5. The following describes the method for fabricating the fuel cell stack of Example 1.

First, as electrolyte membrane 302, Nafion®117 (provided by DuPont) was prepared which had a size of 25 mm in width×25 mm in length and a thickness of approximately 175 μm. Then, catalyst-supported carbon particles (TEC66E50 provided by TANAKA KIKINZOKU) consisting of Pt particles, Ru particles, and carbon particles with a Pt content of 32.5% by mass and a Ru content of 16.9% by mass, an alcohol solution (provided by Aldrich) including Nafion® of 20% by mass, isopropanol, and an alumina ball were introduced into a Teflon® container at a mass ratio of 0.5:1.5:1.6:100. They were mixed at 500 rpm for 50 minutes using an agitator/deaerator to prepare an anode catalyst paste.

On the other hand, a cathode catalyst paste was prepared in a manner similar to that for the anode catalyst paste, apart from use of catalyst-supported carbon particles (TEC10E50E provided by TANAKA KIKINZOKU) consisting of Pt particles and carbon particles and having a Pt content of 46.8% by mass.

Utilized as the porous base for the anode electrode was a carbon paper (25BC provided by SGL The Carbon Company) having an outer shape of 23 mm×23 mm and having a surface treated to be water-repellent with a layer (microporous layer) including a fluorine-based resin and carbon particles. The above-described anode catalyst paste was screen-printed onto the entire water-repellent surface of the carbon paper so that the catalyst content was 2 mg/cm², using a screen printing plate having a square-shaped opening having a size of 23 mm in width×23 mm in length. Thereafter, the screen-printed anode catalyst paste was dried at a room temperature to obtain anode electrode 303 having a catalyst layer with a thickness of approximately 20 μm. In a manner similar to that for the anode electrode, the cathode catalyst paste was screen-printed to a carbon paper (25BC provided by SGL The Carbon Company) to form cathode electrode 304 having a catalyst layer with a thickness of approximately 20 μm.

Next, the anode electrode, the above-described electrolyte membrane and the cathode electrode were stacked in this order so that the anode electrode and the cathode electrode overlapped with each other with the electrolyte membrane therebetween at the center of the electrolyte membrane and the anode and the cathode catalyst layer are in contact with the electrolyte membrane. This stacked structure was provided in a through hole of a frame-shaped Teflon spacer (Teflon®) having a size of 100 mm×100 mm and a thickness of 0.30 mm. The through hole was in the form of a square of 50 mm×50 mm. They were interposed between stainless steel plates each having a size of 100 mm×100 mm and a thickness of 3 mm, and the stacked structure was then thermocompression bonded in the thickness direction of the stainless steel plate at 130° C. with 5 kgf/cm² for two minutes, to obtain a membrane electrode assembly in which the electrolyte membrane and the electrodes were integrated.

Then, anode collector layer 305 was fabricated as follows. That is, a flat plate made of sulfuric acid-resistant stainless steel SUS316L and having a width of 25 mm, a length of 25 mm, and a thickness of 300 μm was etched to form through holes 308 and fuel flow paths 307, thereby obtaining anode collector layer 305. Anode collector layer 305 included twelve rows of through holes 308 (diameter of 300 μm). Each of the rows was made up of thirteen through holes 308 arranged in parallel with the length direction of the stainless steel flat plate. A through hole located at the very end of each row was away from the end of the stainless steel flat plate in the length direction thereof by a distance of 1 mm. A distance between the centers of adjacent through holes in the same row was 2 mm. A distance between adjacent rows (distance between the center of a through hole in one row and the center of a through hole in the other row) was 1100 μm. Further, anode collector layer 305 included eleven fuel flow paths 307 each formed between the rows of the through holes and constituted by a groove extending in parallel with the length direction of the stainless steel flat plate and having a depth of 200 μm and a width of 500 μm. The end of the through holes and the edge of both of the grooves constituting each fuel flow paths 307 and being arranged adjacent to the through holes were separated by a distance of 150 μm.

Then, a dry film formed of a resist resin having a thickness of 45 μm was hot-laminated on the entire surface of anode collector layer 305, was exposed using a photo resist mask, was developed, and then was cured at 350° C., thereby forming each of fuel permeation layers 311. Fuel permeation layer 311 had a width of 650 μm while each fuel flow path 307 had a width of 500 μm, and was formed to cover the groove of fuel flow path 307. Fuel permeation layer 311 thus formed lay off the groove by 75 μm at the left and right sides thereof. Then, at the center of fuel permeation layer 311, a plurality of openings each having a width of 10 μm were provided in a row at a pitch of 600 μm in the longitudinal direction thereof.

Anode collector layer 305 with fuel permeation layer 311, anode electrode 303, electrolyte membrane 302, and cathode electrode 304 were stacked in this order from below. This stacked structure was provided in a through hole of a frame-shaped Teflon spacer (Teflon®) having a size of 100 mm×100 mm and a thickness of 0.6 mm. The through hole was in the form of a square of 50 mm×50 mm. They were then interposed between stainless steel plates each having a size of 100 mm×100 mm and a thickness of 3 mm, and then the stacked structure was thermocompression bonded in the thickness direction of the stainless steel plates at 130° C. with 5 kgf/cm² for two minutes to integrate the stacked structure, thereby fabricating first unit cell 301a. In the same manner as that for first unit cell 301a, second unit cell 301b was fabricated.

Meanwhile, each of spacers 306 was fabricated as follows. A flat plate having an outer shape of 1×25 mm and a thickness of 400 μm and formed of acid-resistant stainless steel SUS316 was etched to provide a groove having a depth of 200 μm and a width of 500 μm such that the center of the groove and the center of the spacer flat plate overlapped with each other, thereby forming exhaust flow path 309.

Then, an electrically conductive paste (CARBOLLOID MRX-713J provided by TAMURA KAKEN CORPORATION) was applied by a screen printing method onto spacer 306 on its surface on which exhaust flow path 309 was formed, at a portion other than exhaust flow path 309, so as to obtain an application thickness of 30 μm. Thereafter, spacers 306 were arranged at a pitch of 2 mm and stacked such that fuel flow paths 307 of anode collector layer 305 of second unit cell 301b were orthogonal to the longitudinal direction of each spacer 306 and through holes 308 of anode collector 305 and the exhaust flow path 309 surface of spacer 306 overlapped with each other. This stacked structure was provided in a through hole of a frame-shaped Teflon spacer (Teflon®) having a size of 100 mm×100 mm and a thickness of 1 mm. The through hole was in the form of a square of 60 mm×60 mm. They were interposed between stainless steel plates having a size of 100 mm×100 mm and a thickness of 3 mm. Thereafter, the stacked structure was thermocompression bonded in the thickness direction of each stainless steel plate at 130° C. with 5 kgf/cm² for 30 minutes to integrate the stacked structure, thereby fabricating the stacked structure (fuel cell) of second unit cell 301b and spacers 306.

Next, an electrically conductive paste (CARBOLLOID MRX-713J provided by TAMURA KAKEN CORPORATION) was applied by the screen printing method to an opposite surface of spacers 306 to its surface joined to second unit cell 301b, so as to obtain an application thickness of 20 μm. Then, the cathode electrode 304 surface of first unit cell 301a and the electrically conductive paste applied surface of spacers 306 were disposed to face each other and thus first unit cell 301a and second unit cell 301b were stacked on each other to overlap with each other with spacers 306 interposed therebetween. This stacked structure was provided in a through hole of a frame-shaped Teflon spacer (Teflon®) having a size of 100 mm×100 mm and a thickness of 1.5 mm. The through hole was in the form of a square of 60 mm×60 mm. They were then interposed between stainless steel plates each having a size of 100 mm×100 mm and a thickness of 3 mm, and the stacked structure was thermocompression bonded in the thickness direction of each stainless steel plate at 130° C. with 5 kgf/cm²for 30 minutes to fabricate fuel cell stack 300.

Next, a Teflon® tube having an external diameter of 360 μmφ (internal diameter of 150 mmφ) was inserted from the end of fuel flow path 307 into the fuel flow path, and a space between the tube and the end of fuel flow path 307 was filled with an epoxy resin, which was then dried to form a connection portion for the supply of fuel. Then, a 3M methanol aqueous solution was supplied using a pump at a rate of 0.5 cc/min for power generation. A maximum power density obtained was 34 mW/cm².

### Example 2

In the present example, a fuel cell stack (fuel cell stack of Example 2) was fabricated which had a structure similar to that of fuel cell stack 500 shown in FIG. 7 and FIG. 8. The following describes the method for fabricating the fuel cell stack of Example 2.

Each of spacers 506 was fabricated as follows. A titanium foil having an outer shape of 1×25 mm and a thickness of 100 μm was disposed on a titanium fiber sintered compact (provided by Bekinit K. K.) with an outer shape of 1×25 mm, a thickness of 600 μm, and a porosity of 80% so that their outer shapes overlapped with each other. The titanium fiber sintered compact and the titanium foil were bonded to each other by means of spark plasma sintering. The bonded structure was pressed to fabricate spacer 506 having a groove with a depth of 200 μm and a width of 500 μm on the titanium foil side of the bonded structure so that the groove was formed at the center of the bonded structure and a total thickness of the bonded structure is 400 μm. Apart from the use of spacer 506, fuel cell stack 500 was fabricated in a manner similar to that in Example 1. Power generation was evaluated in a manner similar to that in Example 1. A maximum power density obtained was 40 mW/cm².

### Example 3

In the present example, a fuel cell stack (fuel cell stack of Example 3) was fabricated which had a structure similar to that of fuel cell stack 600 shown in FIG. 9 and FIG. 10. The following describes the method for fabricating the fuel cell stack of Example 3.

First, a membrane electrode assembly was fabricated in a manner similar to that in Example 1, and was cut by a trimming knife to have an outer shape of 2 mm×25 mm and an electrode portion of a size of 2 mm×23 mm, thereby obtaining a membrane electrode assembly that is in a shape of an elongated strip.

Meanwhile, anode collector layer 605 was fabricated as follows. A flat plate having a width of 2 mm, a length of 25 mm, and a thickness of 300 μm and formed of sulfuric acid-resistant stainless steel SUS316L was etched to form through holes 608 and fuel flow path 607, thereby obtaining anode collector layer 605. Anode collector layer 605 included two rows of through holes 608 (diameter of 300 μm). Each of the rows included thirteen through holes 608 arranged in parallel with the length direction of the stainless steel flat plate. A through hole at the very end of each row and the end of the stainless steel flat plate in the length direction were separated from each other by a distance of 1 mm. A distance between the centers of adjacent through holes in the same row was 2 mm. The end of the stainless steel flat plate in the width direction and each of the through holes were separated from each other by a distance of 150 μm. Further, anode collector layer 605 included one fuel flow path 607, which was constituted by a groove formed between the rows of the through holes, extending in parallel with the length direction of the stainless steel flat plate, and having a depth of 200 μm and a width of 800 μm. A distance between the end of the through holes and the edge of both of the grooves constituting fuel flow paths 607 and being arranged adjacent to the through holes was 150 μm.

Then, a dry film formed of a resist resin having a thickness of 45 μm was hot-laminated on the entire surface of anode collector layer 605, was exposed using a photo resist mask, was developed, and was then cured at 350° C. to form each of fuel permeation layers 611. Fuel permeation layer 611 had a width of 950 μm while fuel flow path 607 had a width of 800 μm, and was formed to cover the groove of fuel flow path 607. Fuel permeation layer 611 thus formed lay off the groove by 75 μm at the left and right sides thereof. Then, a plurality of openings each having a width of 10 μm were provided at a pitch of 600 μm in one row at the center of fuel permeation layer 611 in the longitudinal direction thereof.

Anode collector layer 605 with fuel permeation layer 611, anode electrode 603, electrolyte membrane 602, and cathode electrode 604 were stacked in this order from below. This stacked structure was provided in a through hole of a frame-shaped Teflon spacer (Teflon®) having a size of 100 mm×100 mm and a thickness of 0.6 mm.

The through hole was in the form of a square of 50 mm×50 mm. They were then interposed between stainless steel plates each having a size of 100 mm×100 mm and a thickness of 3 mm, and then the stacked structure was thermocompression bonded in the thickness direction of the stainless steel plate at 130° C. with 5 kgf/cm² for two minutes so as to integrate the stacked structure, thereby fabricating unit cell 601. In the same way, fifteen unit cells 601 were fabricated in total.

Each of spacers 606 was fabricated as follows. A titanium foil having an outer shape of 1×14 mm and a thickness of 100 μm was stacked on a titanium fiber sintered compact (provided by Bekinit K. K.) with an outer shape of 1×14 mm, a thickness of 600 μm, and a porosity of 80% so that their outer shapes overlapped with each other. Then, the titanium fiber sintered compact and the titanium foil were bonded by means of spark plasma sintering. The bonded structure was pressed to fabricate spacer 606 having a groove having a depth of 100 μm and a width of 500 μm on the titanium foil side of the bonded structure so that the groove was formed at the center of the bonded structure and a total thickness of the bonded structure is 400 μm.

Then, the first unit cell layer was formed by disposing five unit cells 601 on a plane so that their longer sides faced one another and gaps 614 of 1 mm were provided between the longer sides thus facing one another. Then, an electrically conductive paste (CARBOLLOID MRX-713J provided by TAMURA KAKEN CORPORATION) was applied by the screen printing method to spacer 606 on its surface on which exhaust flow path 609 was formed, at a portion other than exhaust flow path 609, so as to obtain an application thickness of 30 μm. Spacers 606 were arranged and provided at a pitch of 2 mm on the first unit cell layer so that they were orthogonal to unit cells 601 of the first unit cell layer and through holes 608 of anode collector layer 605 and the exhaust flow path 609 surface of each spacer 606 overlapped with each other. This stacked structure was provided in a through hole of a frame-shaped Teflon spacer (Teflon®) having a size of 100 mm×100 mm and a thickness of 1 mm The through hole was in the form of a square of 50 mm×50 mm. They were interposed between stainless steel plates each having a size of 100 mm×100 mm and a thickness of 3 mm, and the stacked structure was thermocompression bonded in the thickness direction of the stainless steel plate at 130° C. with 5 kgf/cm² for 30 minutes so as to integrate the stacked structure, thereby fabricating the stacked structure of the first unit cell layer and spacers 606.

Then, in a manner similar to that for the first unit cell layer, the second unit cell layer was fabricated by disposing unit cells 601. Next, an electrically conductive paste (CARBOLLOID MRX-713J provided by TAMURA KAKEN CORPORATION) was applied by the screen printing method to the stacked structure of the first unit cell layer and spacers 606 at its surface opposite to the surface on which spacers 606 were provided, so as to obtain an application thickness of 30 μm. Next, spacers 606 and the second unit cell layer were stacked in this order on the stacked structure of the first unit cell layer and spacers 606 so that the unit cells of the first unit cell layer and the unit cells of the second unit cell layer overlapped correspondingly with spacers 606 interposed therebetween and cathode electrode 604 of each of the unit cells constituting the second unit cell layer face spacers 606. This stacked structure was then provided in a through hole of a frame-shaped Teflon spacer (Teflon®) having a size of 100 mm×100 mm and a thickness of 1.5 mm. The through hole was in the form of a square of 50 mm×50 mm. They were then interposed between stainless steel plates each having a size of 100 mm×100 mm and a thickness of 3 mm, and then the stacked structure was thermocompression bonded in the thickness direction of the stainless steel plate at 130° C. with 5 kgf/cm² for 30 minutes so as to integrate the stacked structure, thereby fabricating the stacked structure in which spacers 606, the first unit cell layer, spacers 606, and the second unit cell layer are stacked in this order from the top thereof.

Then, in a manner similar to that of fabricating the stacked structure of the first unit cell layer and spacers 606, anode collector layer 605 of the second unit cell layer and spacers 606 were stacked on one another and integrated. A frame-shaped Teflon spacer (Teflon®) used on this occasion had a thickness of 1.9 mm.

Then, as with the first unit cell layer and the second unit cell layer, a third unit cell layer was fabricated by disposing unit cells 601. In a manner similar to that of fabricating the stacked structure consisting of spacers 606, the first unit cell layer, spacers 606, and the second unit cell layer in this order, fuel cell stack 600 was fabricated which had a stacked structure consisting of spacers 606, the first unit cell layer, spacers 606, the second unit cell layer, spacers 606, and the third unit cell layer in this order from the top thereof. A frame-shaped Teflon spacer (Teflon®) used on this occasion had a thickness of 2.4 mm.

Next, in a manner similar to that in Example 1, power generation was evaluated. A maximum power density obtained was 43 mW/cm².

It should be considered that the embodiments and examples disclosed herein are illustrative and non-restrictive in any respect. The scope of the present invention is defined by the scope of claims rather than the description above, and is intended to include any modifications within the scope and meaning equivalent to the terms of the claims.

### DESCRIPTION OF THE REFERENCE SIGNS

100, 300, 400, 500, 600: fuel cell stack; 101a, 301a, 401a, 501a: first unit cell; 101b, 301b, 401b, 501b: second unit cell; 201, 601, 701: unit cell; 102, 302, 402, 502, 602, 702: electrolyte membrane; 103, 303, 403, 503, 603, 703: anode electrode; 104, 304, 404, 504, 604, 704: cathode electrode; 105, 305, 405, 505, 605, 705: anode collector layer; 106, 206, 306, 406, 506, 606, 706: spacer; 107, 307, 407, 507, 607, 707: fuel flow path; 108, 308, 408, 508, 608, 708: through hole; 109, 309, 409, 509, 609, 709: exhaust flow path; 110, 410, 510, 610: space portion; 311, 411, 511, 611: fuel permeation layer; 412, 512, 612: water-repellent porous portion; 513: exhaust flow path wall; 614: gap; 615: gas-permeation retarding layer; 700: fuel cell.

1. A fuel cell comprising:
a first unit cell including a cathode electrode, an electrolyte membrane, an anode electrode, and an anode collector layer in this order; and
one or more spacers arranged on said anode collector layer,
said anode collector layer having a fuel flow path for supplying fuel to said anode electrode and a through hole for exhausting a reaction product generated by reaction in said anode electrode,
each of said spacers having an exhaust flow path for exhausting said reaction product to outside said fuel cell,
said through hole and said exhaust flow path communicating with each other.

2. The fuel cell according to claim 1, wherein:
said first unit cell is in a shape of an elongated strip with a longer side and a shorter side, and
each of said spacers is arranged such that a longitudinal direction of each of said spacers intersects with a direction of the longer side of said first unit cell.

3. The fuel cell according to claim 1, wherein said through hole has an inner wall surface having a water-repellent property.

4. A fuel cell stack at least comprising:
the fuel cell recited in claim 1; and
a second unit cell including a cathode electrode, an electrolyte membrane, an anode electrode, and an anode collector layer in this order,
said second unit cell being arranged on said fuel cell such that said cathode electrode of said second unit cell is in contact with said spacers.

5. The fuel cell stack according to claim 4, wherein:
each of said spacers is formed of a porous body, and
each of said spacers has a surface constituting an inner wall of said exhaust flow path and said surface is covered with a material having a gas-permeation retarding property.

6. A fuel cell stack at least comprising:
a unit cell layer in which two or more unit cells are arranged in the same plane with a gap therebetween, said unit cells including a cathode electrode, an electrolyte membrane, an anode electrode, and an anode collector layer in this order; and
a spacer layer arranged on said unit cell layer, said spacer layer being constituted of two or more spacers,
said spacers being arranged to intersect with said gap provided in said unit cell layer,
said anode collector layer having a fuel flow path for supplying fuel to said anode electrode and a through hole for exhausting a reaction product generated by reaction in said anode electrode,
each of said spacers having an exhaust flow path for exhausting said reaction product to outside said fuel cell stack,
said through hole and said exhaust flow path communicating with each other.

7. The fuel cell stack according to claim 6, wherein said unit cells and/or said spacers are in a shape of an elongated strip.
